(19) United States
(12) Patent Application Publication
(10) Pub. No.: US 2008/0212786 A1
(43) Pub. Date: Sep. 4, 2008

(54) METHOD AND APPARATUS TO REPRODUCE MULTI-CHANNEL AUDIO SIGNAL IN MULTI-CHANNEL SPEAKER SYSTEM

(75) Inventor: Hae-kwang PARK, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/845,271

(22) Filed: Aug. 27, 2007

(30) Foreign Application Priority Data
Mar. 2, 2007 (KR) 2007-21150

(51) Int. Cl. H04R 5/00

(52) U.S. Cl. 381/27

(57) ABSTRACT

A method and an apparatus to reproduce a multi-channel audio signal, in which mixing of a center channel signal is performed with a center channel signal in a home theater system. The method of reproducing a multi-channel audio signal includes calculating a delay value of a center channel signal according to location relationships of a listener, a center channel speaker and other channel speakers, regulating a time delay of the center channel signal according to the calculated delay value, and mixing the time-delay regulated center channel signal with other channel signals.

### CROSS-REFERENCE TO RELATED APPLICATIONS

This application claims the benefit of Korean Patent Application No. 10-2007-0021150, filed on May 2, 2007, in the Korean Intellectual Property Office, the disclosure of which is incorporated herein in its entirety by reference.

### BACKGROUND OF THE INVENTION

1. Field of the Invention

The present general inventive concept relates to a multi-channel speaker system, and more particularly, to a method and an apparatus to reproduce a multi-channel audio signal that performs mixing of a signal of a center channel to left and right channels in a home theater system.

2. Description of the Related Art

Recently, home theater systems have been developed and launched. Home theater systems reproduce video and audio that are recorded in various recording media such as DVDs, HDDs, tapes or the like and output the video reproduced from the recording media onto wide screen televisions.

In addition, home theater systems separate and output audio channels of audio reproduced from recording media, for example, multi-channel audio of 5.1 channel surround sound that is reproduced from DVD through six speakers that are separated and equipped at different locations.

In addition, home theater systems simply perform mixing of audio signals of left and right channels and output the audio signals of the left and right channels as an audio signal of a center channel.

However, in home theater systems, speech cannot sometimes be clearly conveyed to a listener due to the volume of the center channel, locations of speakers, a difference in speaker units or the like.

FIG. 1 is a conceptual view illustrating an effect of a time-delayed signal, which occurs according to a listener's location in conventional mixing of a center sound.

When two sounds having the same frequency and sound pressure are simultaneously reproduced through two speakers in a conventional stereo system, the two sounds sound like a sound generated from the front center with respect to human ears. Likewise, when a sound image is positioned in the front center of speakers, it is said that 'a sound image is localized. The localization of the sound image is determined according to level, phase and time differences between each of the left and right speakers and a listener. When the same sounds are heard in different directions after a certain interval, a last sound is masked by a first sound. Accordingly, the listener can hear in a direction of a sound source of the first sound. This phenomenon is known as a “precedence effect,” “Haas effect” or “first front wave law.”

Referring to FIG. 1, two speakers SL and SR are arranged at left and right sides, and a listener is positioned in the front center of the two speakers. A sound signal is directly input to the left speaker SL, and a sound delayed by a time τd is input to the right speaker SR. When the delayed time difference (τd)=0 ms, that is, when left and right signals simultaneously arrive at the ears of the listener, the sound image is positioned in the center A of the two speakers SL and SR. As the delayed time difference τd gradually increases, the left signal arrives more quickly at the ears of the listener than the right signal, and the sound image is gradually moved towards a left side. A moving degree of the sound image is gradually changed according to the type of sound source and the listener's location. However, the sound image is moved in proportion to the time difference τd towards each speaker from the center of the speakers at a time difference of less than 1 ms. The sound image sounds as if a sound is output from only one speaker at a time difference in the range of 1 to 30 ms.

Accordingly, when a listener is closer to one speaker than other speakers, a center sound, on which mixing is performed, may be heard from only one speaker, which is closest to a listener, using a conventional mixing manner of a center sound.

### SUMMARY OF THE INVENTION

The present general inventive concept provides a method and apparatus to reproduce a multi-channel audio signal on which mixing is performed with respect to left and right channels by reflecting a time delay according to a location of a speaker with respect to a signal of a center channel in a home theater system.

The present general inventive concept also provides a multi-channel speaker system in which a method and an apparatus for reproducing multi-channel audio signals.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of reproducing a multi-channel audio signal including calculating a delay value of a center channel signal according to location relationships of a listener, a center channel speaker and other channel speakers, regulating a time delay of the center channel signal according to the calculated delay value, and mixing the time-delay regulated center channel signal with other channel signals.

The foregoing and/or other aspects and utilities of the present general inventive concept may also be achieved by providing an apparatus to reproduce a multi-channel audio signal, the apparatus including a delay unit to time-delay a signal of a center channel according to a delay value of the center channel, which is calculated according to location relationships of a listener, a center channel speaker and other channel speakers, a mixing gain unit to regulate a gain of a center channel signal by providing a gain value, which is already set, to the time-delayed center channel signal, and a mixing unit to mix the signal of the center channel, on which the time delay is performed and a gain is regulated, with signals of other channels.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a conceptual view illustrating an effect of a time-delayed signal, which occurs according to a listener's location in conventional mixing of a center sound;

FIG. 2 is a conceptual view of a method of reproducing a multi-channel signal according to an embodiment of the present general inventive concept;

FIG. 3 is a block diagram of a multi-channel speaker system according to an embodiment of the present general inventive concept;

FIG. 4 is a view of the mixing processing unit 330 illustrated in FIG. 3;

FIG. 5 is a graph illustrating a common Haas effect in terms of equations; and

FIGS. 6A and 6B are arrangement views to calculate movement and orientation of a sound image according to a listener's location when a right speaker and a center speaker are used, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

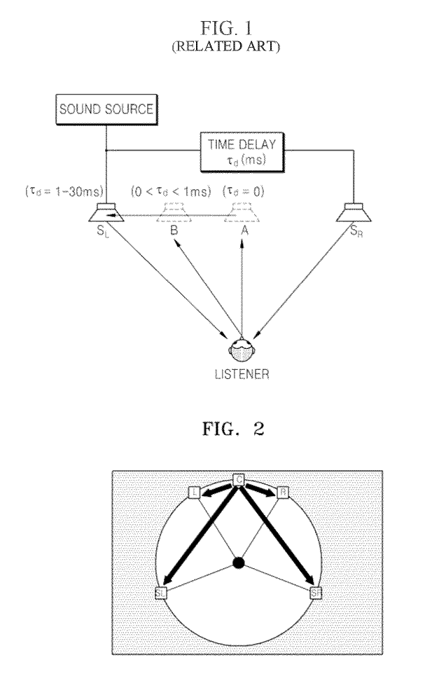

FIG. 2 is a conceptual view of a method of reproducing a multi-channel signal according to an embodiment of the present general inventive concept.

Referring to FIG. 2, assuming that 5-channel audio is input, there are five speakers with respect to a listener, including a left channel L, a right channel R, a center channel C, a left surround channel SL and a right surround channel SR.

At this time, mixing is performed between an audio signal of the center channel C and audio signals of the left channel L and the right channel R. In addition, mixing is performed between the audio signal of the center channel C and audio signals of the left surround channel SL and the right surround channel SR.

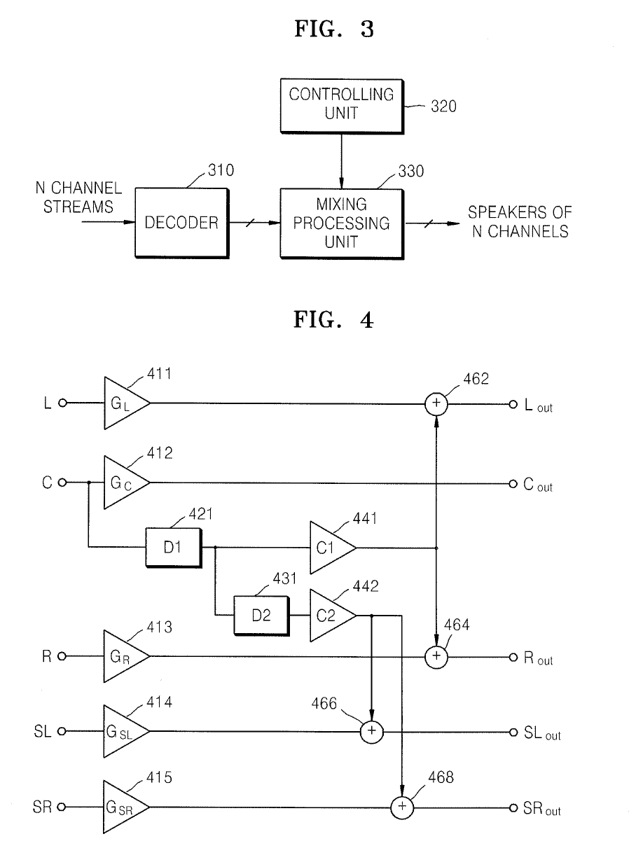

FIG. 3 is a block diagram of a multi-channel speaker system according to an embodiment of the present general inventive concept.

Referring to FIG. 3, the multi-channel speaker system includes a decoder 310, a controlling unit 320 and a mixing processing unit 330.

The decoder 310 separates N channel audio bit streams input from a signal reproducer into audio signals having N channels (e.g. a left channel L, a right channel R, a center channel C, a left surround channel SL and a right surround channel SR).

The controlling unit 320 recognizes locations of the listener and a speaker of each channel, and calculates a delay value of a signal of the center channel C according to location relations of the listener, a center channel speaker and another channel speaker. Since methods of recognizing a location are well known to one of ordinary skill in the art, the embodiments herein are not limited to a specific method. As an example, the locations of the listener and the speaker can be recognized by using a camera or an ultrasonic sensor. The delay value is calculated using a processing method including calculating a signal delay and a signal sound pressure level difference between a center channel speaker and another channel speaker, calculating a distance for which a sound image of a center channel is moved from the center of the two speakers, setting a threshold from a sound pressure level difference between two channel speakers, and converting a distance between a listener and each of two speakers into the delay value within the threshold. At this time, the delay value is a parameter that can localize a signal of a center channel to the location of the center speaker irrespective of a change in the listener's location.

The mixing processing unit 330 regulates a time delay of the center channel signal separated by the decoder 310 according to the delay value calculated by the controlling unit 320, and performs mixing the signal of the center channel with the signals of another channel separated by the decoder 310 by providing a mixing gain value that is already set to the center channel of which a time delay is regulated.

FIG. 4 is a view of the mixing processing unit 330 illustrated in FIG. 3.

Referring to FIG. 4, first, second, third, fourth and fifth gain units 411, 412, 413, 414 and 415 respectively regulate gains of a left channel L signal, a right channel R signal, a center channel C signal, a left surround channel SL signal and a right surround channel RL signal. That is, the gain of the left channel L signal is changed by a gain value G_{L} of the first gain unit 411. The gain of the center channel C signal is changed by a gain value G_{C} of the second gain unit 412. The gain of the right channel R signal is changed by a gain value G_{R} of the third gain unit 413. The gain of the left surround channel SL signal is changed by a gain value G_{SL} of the fourth gain unit 414. The gain of the right surround channel SR signal is changed by a gain value G_{SR} of the fifth gain unit 415.

A first delay unit 421 reflects a delay value D1 according to the locations of speakers in order to delay the center channel C signal for a predetermined period of time.

A first mixing gain unit 441 provides a fixed gain value C1 to the center channel C signal that is delayed in the first delay unit 421 in order to perform mixing between the center channel C signal and each of the left and right channel L and R signals.

A second delay unit 431 reflects a delay value D2 according to the locations of speakers to delay the center channel C signal that is delayed in the first delay unit 421 for a predetermined period of time.

A second mixing gain unit 442 provides a fixed gain value C2 to the center channel C signal that is delayed in the second delay unit 431 in order to perform mixing between the center channel C signal and each of the left and right surround channel L and R signals.

A first mixing unit 462 performs mixing between the left channel L signal output by the first gain unit 411 and the center channel C signal output by the first mixing gain unit 441.

A second mixing unit 464 performs mixing between the right channel R signal output by the third gain unit 413 and the center channel C signal output by the first mixing gain unit 441.

A third mixing unit 466 performs mixing between the left surround channel L signal output by the fourth gain unit 414 and the center channel C signal output by the second mixing gain unit 442.

A fourth mixing unit 468 performs mixing between the right surround channel R signal output by the fifth gain unit 415 and the center channel C signal output by the second mixing gain unit 442.

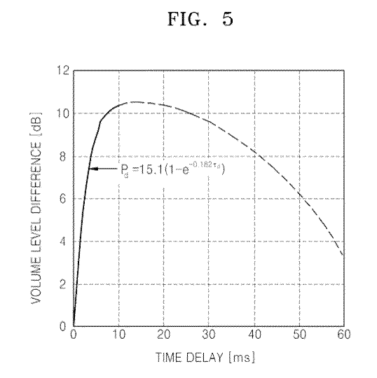

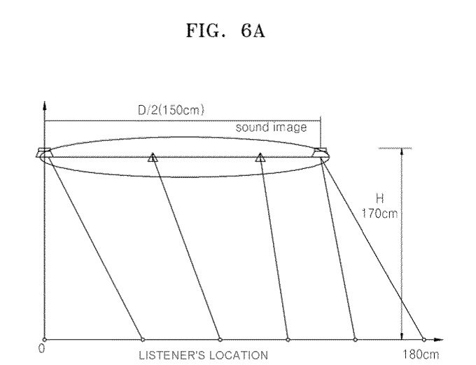

FIG. 5 is a graph illustrating a common Haas effect in terms of equations.

Referring to FIG. 5, an X-axis represents a time delay, and a Y-axis represents a volume level difference. That is, the graph illustrated in FIG. 5 illustrates the relationship between the time delay and the volume level difference. In addition, modeling can be performed with respect to the relationship between the time delay and the volume level difference in terms of equations, within a time delay of 60 ms. Accordingly, a sound pressure difference P_{d} calculated by modeling is given by Equation 1 below.

P_{d}=15.1(1−e^{-0.182τd}) Equation 1

For example, referring to FIG. 5, when the time delay is 5 ms, a volume level difference should be maintained at 7.5 dB.

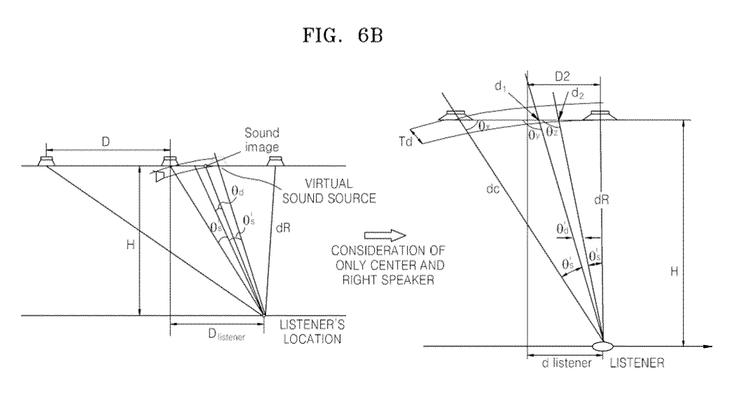

FIGS. 6A and 6B are arrangement views to calculate movement and orientation of a sound image according to a listener's location when a right speaker and a center speaker are used, according to an embodiment of the present general inventive concept.

Referring to FIGS. 6A and 6B, an operation of setting the delay value and the gain value as illustrated in FIG. 4 will be described.

First, when the listener moves towards the right from a front center position (a location of a center speaker), a sound image of the center speaker is gradually moved, as illustrated in FIG. 6A. A distance d_{R} between the listener and the right speaker and a distance d_{C} between the listener and the center speaker are respectively given by Equations 2 and 3 below. Here, dₗᵢₛₜₙₑᵣ is a moving distance of the listener, H is a distance between the listener and the speaker, and D is a distance between speakers.

d_{R}=\sqrt{(H)²+(D/2−dₗᵢₛₜₙₑᵣ)²} Equation 2

dc=\sqrt{(H)²+(D/2+dₗᵢₛₜₑₙₑᵣ)²} Equation 3

A distance difference ddiff is given by Equation 4 using dR and dC.

d_{diff}=d_{C}−d_{R} Equation 4

In addition, when the distance difference d_{diff} is converted into a time difference t_{diff}, the conversion is given be Equation 5. Here, vₛ is about 340 m/s which is the propagation velocity of a sound wave.

t_{diff}=d_{diff}/vₛ Equation 5

When modeling is performed with respect to the relationship between the time delay and the volume level difference in terms of equations, within a time difference of 60 ms, the relationship is given by Equation 1. A sound pressure level difference P_{D} according to a distance ratio between the listener and each of the left and right speakers is given by Equation 6.

P_{D}=20 log(d_{R}/d_{C}) Equation 6

Accordingly, a total sound pressure level difference Pₜ is given by Equation 7. Here, P_{H} is a sound pressure level difference according to a level ratio of a signal.

Pₜ=P_{H}+P_{D} Equation 7

Meanwhile, a sound pressure level difference k between the left and right speakers, which is obtained using linear scale, is given by Equation 8.

k=10^{Pt/20} Equation 8

Referring to FIG. 6B, when a sound pressure level of both ears are the same in the listener's location, a sound image exists in the center of an angle between the two speakers viewed from the listener's location.

The angle θ′ₛ between the two speakers, where the sound image exists, can be given by Equation 9.

$${θ}_{s}^{′} = \frac{1}{2} {cos}^{- 1} ( \frac{{d}_{R}^{2} + {d}_{C}^{2} - {D}^{2}}{2 \times {d}_{R} \times {d}_{C}} ) \qquad Equation 9$$

In FIG. 6B, angles θₓ, θ_{y} and θ_{z}, which are used to calculate a distance d₁ in which the sound image is moved from the center of the two left and right speakers, can be given by Equations 10, 11 and 12, respectively.

$${θ}_{x} = {cos}^{- 1} ( \frac{{d}_{C}^{2} + {D}^{2} - {d}_{R}^{2}}{2 \times {d}_{C} \times D} ) \qquad Equation 10$$

θ_{y}180−θ₁−θₓ Equation 11

θ_{z}=180−(180−θ_{y})−θ′_{d} Equation 12

Accordingly, a distance d₁, in which the sound image is moved from the center of the two speakers, is given be Equation 13.

$${d}_{1} = {d}_{L} \frac{sin {θ}_{s}^{′}}{sin {θ}_{y}} - D / 2 \qquad Equation 13$$

A sound image direction θ′_{d} that is calculated in the listener's location according to the sound pressure level difference k of the left and right speakers is given by Equation 14 with respect to the angle θ′ₛ between the two speakers where the sound image exists.

$${θ}_{d}^{′} = {sin}^{- 1} ( \frac{1 - k}{1 + k} sin {θ}_{s}^{′} ) \qquad Equation 14$$

When the sound image is moved a distance d₂ according to the sound image direction θ′_{d} with respect to the distance d₁, a distance dₜ, which a center sound image is moved from the center of the two speakers, is given by Equation 15.

dₜ=d₁+d₂ Equation 15

If a center channel signal level, on which mixing is performed with respect to another channel signal, is the same or smaller than a signal level that is reproduced by the center channel speaker, the distance difference ddiff given by Equation 4 may be a negative enough value in order to prevent the sound image of the center speaker from moving.

Assuming that a distance difference between the two speakers is within 5 m, according to listening circumstances of a conventional home theater system, when a level of the center channel signal on which mixing is performed is smaller than a signal that is reproduced in the center speaker, the center sound can be prevented from being moved so as to have a time difference of 6 ms or more according to the Haas effect illustrated in FIG. 5. Here, the distance which the sound image is moved, can be given with respect to the time difference t_{diff} using Equation 5. Accordingly, the delay value D1 of the first delay unit 421 illustrated in FIG. 4 may be set as 6 ms or more in order to prevent the sound image of the center sound from moving.

In addition, when the localization of the sound image, which is performed by mixing of the surround channel, the center channel and the front channel, is interpreted in the same manner, a time difference of about 5 ms is required for the surround channel with respect to the front channel. Accordingly, the delay value D2 of the second delay unit 431 illustrated in FIG. 4 may be determined as the delay value D1+5 ms. For the Haas effect, the delay value D1 may be determined as a value in the range of 5 to 15 ms.

Mixing gains C₁ and C₂ may be determined so that gains of the center channel signal and another channel signal do not differ greatly.

Equations 16 and 17 below are two examples of equations that are used to determine the mixing gains C₁ and C₂. Here, α is determined as a constant of 1 or less. When α is about 0.7, the volumes of the center channel, on which mixing is performed and the original center channel are similar. In addition, Equation 17 is an example of determining a mixing gain when the mixing gain C₂ is 0. β is determined as a constant of 1 or less.

Cout=[1−α]

Lout=[1−α]SL+αC

Rout=[1−α]SR+αC

SLout=[1−α]SL+αC

SRout=[1−α]SR+αC Equation 16

Cout=[1β]C

Lout=[1−β]SL+βC

Rout=[1−β]SR+βC

SLout=[1−β]SL

SRout=[1−β]SR Equation 17

The embodiment herein can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the embodiments as described above, tone heterogeneity due to a poor location of a center speaker and a difference in speaker units can be overcome, and articulation of a speech can be improved using a new center channel mixing method without reducing a multi-channel effect. In addition, the present general inventive concept is more effective in a common dwelling environment in which volume cannot be freely increased. The volume reproduced using the embodiments herein is the same value as the sum in terms of energy of a sound that arrives to the ears of a listener and a sound that is delayed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of reproducing a multi-channel audio signal, the method comprising:
calculating a delay value of a center channel signal according to location relationships of a listener, a center channel speaker and other channel speakers;
regulating a time delay of the center channel signal according to the calculated delay value; and
mixing the time-delay regulated center channel signal with other channel signals.

2. The method of claim 1, wherein the calculating of the delay value comprises:
calculating a signal delay and a sound level difference between the center channel speaker and each of the other channel speakers, and calculating a distance in which a sound image of the center channel is moved from the center of the two speakers;
setting a sound pressure difference between the two channel speakers according to the distance which the sound image of the center channel is moved, as a threshold value; and
converting the distance difference between the listener and the two speakers into a signal delay value within the threshold value.

3. The method of claim 2, wherein the distance difference between the listener and the two speakers is a difference value of a distance between the listener and the center speaker and a distance between the listener and each of the other speakers.

4. The method of claim 1, further comprising:
providing a gain value, which is already set, to the signal of the center channel that is time-delay regulated.

5. The method of claim 1, wherein the mixing comprises:
time-delaying the center channel signal according to a set delay value, and
mixing the time-delayed center channel signal with left and right channel signals.

6. A method of reproducing a multi-channel audio signal comprising at least a center channel, the method comprising:
setting a delay value of the center channel signal according to a signal delay and a sound level difference between the center channel speaker and each of other channel speakers, and a distance in which a sound image of the center channel is moved from a center between the center channel speaker and each of the other channel speakers;
time-delaying the signal of the center channel according to the delay value, gain-regulating the signal of the center channel according to a predetermined gain value, and mixing the signal of the center channel and left and right front channels; and
time-delaying the signal of the center channel, which is already time-delayed in the above time-delaying operation, according to a predetermined delay value, gain-regulating the signal of the center channel according to predetermined gain value, and mixing the signal of the center channel and the left and right surround channels.

7. An apparatus to reproduce a multi-channel audio signal, the apparatus comprising:
a delay unit to time-delay a signal of a center channel according to a delay value of the center channel, which is calculated according to location relationships of a listener, a center channel speaker and other channel speakers;
a mixing gain unit to regulate a gain of a center channel signal by providing a gain value, which is already set, to the time-delayed center channel signal; and
a mixing unit to mix the signal of the center channel, on which the time delay is performed and a gain is regulated, with signals of other channels.

8. The apparatus of claim 1, wherein the delay value of the delay unit is a difference value of a distance between the listener and the center speaker and a distance between the listener and each of the other speakers, which is converted into a time difference.

9. A multi-channel speaker system comprising:
a decoder to separate a plurality of channel audio bit streams to audio signals having a plurality of channels;
a controlling unit to recognize locations of a listener and each channel and to calculate a delay value of a center channel signal according to location relationships of the listener, a center channel speaker and other channel speakers; and
a mixing processing unit to regulate a time delay of the center channel signal according to the delay value calculated by the controlling unit, and to mix the center channel signal with other channel signals separated by the decoder by providing a mixing gain value, which is already set, to the center channel signal that is time-delay regulated.

10. The system of claim 9, wherein the mixing processing unit comprises:
a delay unit to perform time delay of the center channel signal according to the delay value;
a mixing gain unit to regulate a gain of the center channel signal by providing a gain value, which is already set, to the center channel signal time-delayed by the delay unit; and
a mixing unit to mix the signal, which is time-delayed and gain-regulated, to other channel signals.

11. The system of claim 10, wherein the delay unit comprises:
a first delay unit to reflect a first delay value according to locations of the speakers in order to delay the center channel signal for a predetermined period of time; and
a second delay unit to reflect a second delay value according to locations of the speakers to delay the center channel signal that is delayed in the first delay unit.

12. The system of claim 11, wherein the mixing gain unit comprises:
a first mixing gain unit to provide a fixed gain value to the center channel signal that is delayed in the first delay unit in order to perform mixing between the center channel signal and each of the left and right channel signals; and
a second mixing gain unit to provide a fixed gain value to the center channel signal that is delayed in the second delay unit in order to perform mixing between the center channel signal and each of the left and right surround channel signals.

13. The system of claim 12, further comprising:
first, second, third, fourth and fifth gain units to respectively regulate gains of the left channel signal, the right channel signal, the center channel signal, the left surround channel signal and the right surround channel signal.

14. The system of claim 13, wherein the mixing unit comprising:
a first mixing unit to provide mixing between the left channel signal output by the first gain unit and the center channel signal output by the first mixing gain unit;
a second mixing unit to provide mixing between the right channel signal output by the third gain unit and the center channel signal output by the first mixing gain unit;
a third mixing unit to provide mixing between the left surround channel signal output by the fourth gain unit and the center channel signal output by the second mixing gain unit; and
a fourth mixing unit to provide mixing between the right surround channel signal output by the fifth gain unit and the center channel signal output by the second mixing gain unit.

15. A method of reproducing a multi-channel audio signal, the method comprising:
mixing an audio signal of a center channel with audio signals of left and right channels; and
mixing an audio signal of the center channel with audio signals of left and right surround channels.

16. The method of claim 15, wherein the audio signal of the center channel mixed with audio signals of left and right channels is the same as the audio signal of the center channel mixed with audio signals of left and right surround channels.
